(19) United States
(12) Patent Application Publication
(10) Pub. No.: US 2017/0144736 A1
(43) Pub. Date: May 25, 2017

(54) SWIMMING WEARABLE DEVICE AND UPPER LIMB WEARABLE DEVICE

(71) Applicants: BOE TECHNOLOGY GROUP CO., LTD., Beijing (CN); BOE OPTICAL SCIENCE AND TECHNOLOGY CO., LTD., Suzhou, Jiangsu (CN)

(72) Inventors: Feng ZHOU, Beijing (CN); Chunlei CAO, Beijing (CN)

(73) Assignees: BOE Technology Group Co., Ltd., Beijing (CN); BOE Optical Science and Technology Co., Ltd., Jiangsu (CN)

(21) Appl. No.: 15/115,468

(22) PCT Filed: Oct. 30, 2015
(86) PCT No.: PCT/CN2015/093399

§ 371 Date: Jul. 29, 2016

(30) Foreign Application Priority Data
Jun. 18, 2015 (CN) 201510341563.1

(51) Int. Cl. B63C 9/125; B63C 9/15; G08B 21/04; A63B 69/00

(52) U.S. Cl. CPC B63C 9/125; A63B 69/00; B63C 9/15; G08B 21/0453; A63B 2208/03; A63B 2244/20; A63B 2230/605

(57) ABSTRACT

A swimming wearable device comprises an upper body wearable device (100) and a lower limb wearable device (2). The upper body wearable device (100) comprises an electronic airbag (11) and the lower limb wearable device (2) comprises a muscle condition monitoring device (21). The muscle condition monitoring device (21) is connected by signal with the upper body wearable device (100) or with the electronic airbag (11) of the upper body wearable device (100). When detecting a muscle spasm in lower limb, the muscle condition monitoring device (21) sends a signal to the upper body wearable device (100) or the electronic airbag (11) of the upper body wearable device (100), so as to make the upper body wearable device (100) activate the electronic airbag (11) to open or to activate the electronic airbag (11) to open. The swimming wearable device can provide certain buoyancy for the swimmer at the occurrence of muscle cramp, thereby reducing drowning accidents and improve safety of swimming exercise. An upper limb wearable device is also provided.

### TECHNICAL FIELD

Embodiments of the present disclosure relate to a swimming wearable device and an upper limb wearable device.

### BACKGROUND

When swimming, leg or foot cramps (also called as muscle spasm) are main causes of drowning. How to enhance safety of swimming exercise and reduce drowning accidents becomes a technical problem to be solved at present.

### SUMMARY

One of the objects of the embodiments of the present disclosure is to provide a swimming wearable device and an upper limb wearable device so as to improve safety of swimming exercise and reduce drowning accidents.

At least one embodiment of the present disclosure provides a swimming wearable device, comprising an upper body wearable device and a lower limb wearable device, wherein

the upper body wearable device comprises an electronic airbag, the lower limb wearable device comprises a muscle condition monitoring device; the muscle condition monitoring device is connected by signal with the upper body wearable device, and when a muscle spasm in lower limb is detected, the muscle condition monitoring device activates the electronic airbag to open.

When a swimmer wearing the swimming wearable device according to the embodiments of the present disclosure swims, the muscle condition monitoring device will send a signal to the upper body wearable device if it detects a spasm in leg or foot, and the upper body wearable device activates the electronic airbag to open. The electronic airbag in an open state can provide certain buoyancy to the swimmer and protect safety of the swimmer. Therefore, the swimming wearable device according to the embodiments of the present disclosure can enhance safety of swimming exercise and reduce drowning accidents.

In one embodiment of the present disclosure, the upper body wearable device comprises a vest-like upper body wearable device, a bandage-like upper body wearable device, an attaching upper body wearable device or an arm wearing upper body wearable device.

In one embodiment of the present disclosure, the lower limb wearable device comprises an ankle wearing lower limb wearable device, a bandage-like lower limb wearable device or an attaching lower limb wearable device

In one embodiment of the present disclosure, the swimming wearable device comprises at least two lower limb wearable device and the upper body wearable device comprises at least one upper limb wearable device, wherein

each upper limb wearable devices comprises an electronic airbag and each of the at least two lower limb wearable devices comprises a muscle condition monitoring device which is connected by signal with the at least one upper limb wearable device. And when a muscle spasm is detected, the muscle condition monitoring device sends a signal to each of the at least one upper limb wearable devices. In response to the signal, the at least one upper limb wearable devices activate the electronic airbag to open.

When a swimmer wearing the swimming wearable device according to the embodiments of the present invention swims, the muscle condition monitoring device will send a signal to the upper body wearable device if a spasm in leg or foot occurs. In response to the signal, the upper limb wearable device can activate the electronic airbag to open. The opened electronic airbag provides certain buoyancy for the swimmer and protect safety of the swimmer.

In one embodiment of the present disclosure, the lower limb wearable device further comprises an alarming device which is connected by signal with the muscle condition monitoring device. And when detecting a muscle spasm, the muscle condition monitoring device sends a signal to the alarming device to activate the alarming device to give an alarm. The alarm signal of the alarming device can notify, the dangerous situation of the swimmer to others or a lifeguard, thereby reducing drowning accidents and further improving the swimmer's safety.

In one embodiment of the present disclosure, the muscle condition monitoring device of each lower limb wearable device is connected by wireless signal with each of the at least two upper limb wearable devices. Connection by wireless signal between the muscle condition monitoring device and the upper body wearable device can reduce binding sense of the swimmer and improve his/her comfort.

In one embodiment of the present disclosure, the upper body wearable device further comprises a display device. The swimmer can be aware of sport information conveniently and timely by observing display information of the display device.

In one embodiment of the present disclosure, at least one of a clock module, a timer module and a mileage calculating module is integrated in the display device.

In one embodiment of the present disclosure, the mileage calculating module comprises a GPS mileage calculating module or a vibration counting mileage calculating module.

At least one embodiment of the present disclosure further provides an upper body wearable device, which comprises an electronic airbag. The upper body wearable device or the electronic airbag is connected by signal with a muscle condition monitoring device of the lower limb wearable device. And when detecting a muscle spasm, the muscle condition monitoring device sends a signal to the upper body wearable device or to the electronic airbag so as to make the upper body wearable device activate the electronic airbag to open or to activate the electronic airbag to open.

In one embodiment of the present disclosure, the upper body wearable device further comprises a display device in which at least one of a clock module, a timer module and a mileage calculating module is integrated.

Drowning accidents can be reduced and safety of swimming exercise can be improved by wearing the lower limb wearable device comprising the muscle condition monitoring device and the upper body wearable device according to the embodiments of the present disclosure.

### BRIEF DESCRIPTION OF THE DRAWINGS

In order to clearly illustrate the technical solutions of the embodiments of the disclosure, the drawings of the embodiments will be briefly described in the following; it is obvious that the drawings described below are only related to some embodiments of the disclosure and thus are not limitative of the disclosure.

FIG. 1 is an illustrative structural view of a swimming wearable device according to an embodiment of the present disclosure;

FIG. 2 is an illustrative structural view of a swimming wearable device according to another embodiment of the present disclosure;

FIG. 3 is an illustrative structural view of a swimming wearable device according to yet another embodiment of the present disclosure;

FIG. 4 is an illustrative structural view of an upper body wearable device and a lower limb wearable device according to an embodiment of the present disclosure;

FIG. 5 is an illustrative structural view of an upper body wearable device according to an embodiment of the present disclosure; and

FIG. 6 is an illustrative structural view of a lower limb wearable device according to an embodiment of the present disclosure.

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. it is obvious that the described embodiments are just a part hut not all of the embodiments of the disclosure. Based on the described embodiments herein, those skilled in the art can obtain other embodiment(s), without any inventive work, which should be within the scope of the disclosure.

To reduce drowning accidents and improve safety of swimming exercise, embodiments of the present invention provide a swimming wearable device and an upper limb wearable device.

As illustrated in FIG. 1, least one embodiment of the present disclosure provides a swimming wearable device comprising an upper body wearable device 100 and a lower limb wearable device 2, wherein:

The upper body wearable device 100 comprises an electronic airbag 11. The lower limb wearable device 2 comprises a muscle condition monitoring device 21, The muscle condition monitoring device 2 is connected with the upper body wearable device 100 by signal or is directly connected with the electronic airbag 11 by signal. When the muscle condition monitoring device 21 detects muscle spasm in lower limb, the muscle condition monitoring device 21 sends a signal to the upper body wearable device 100 or the electronic airbag 11, with which it is connected by signal, so that the electronic airbag 11 is activated to open by the upper body wearable device 100 or the electronic airbag 11 is activated to open by the signal directly.

Forms of the upper body wearable device 100 and the lower limb wearable device 2 are not restricted. For example, the upper body wearable device 100 can be a vest-like upper body wearable device, a bandage-like upper body wearable device, a sticking upper body wearable device or an arm wearing upper body wearable device and etc. The lower limb wearable device 2 can be an ankle wearing lower limb wearable device, a bandage-like lower limb wearable device or a sticking lower limb wearable device and etc.

The electronic airbag comprises an airbag body and a gas generator in which substance such as sodium nitride or ammonium nitrate is stored. When the electronic airbag is activated, the gas generator performs a point explosion action so that the substance stored in the gas generator is decomposed rapidly and a large amount of gas is generated and fills the airbag. In one embodiment, the muscle condition monitoring device is connected by signal with the upper limb wearable device or the electronic airbag, and when detecting muscle spasm in lower limb, the muscle condition monitoring device sends an electrical signal to the upper limb wearable device or the electronic airbag, which in response to the electrical signal activates the gas generator to perform a point explosion action, so that the substance such as sodium nitride or ammonium nitrate stored in the gas generator is decomposed rapidly and thus a large amount of non-toxic and unscented gas is generated and fills the airbag which provides certain buoyancy for a swimmer.

When a swimmer wearing the swimming wearable device provided by the embodiments of the present disclosure swims, the muscle condition monitoring device sends a signal to the upper body wearable device or the electronic airbag after detecting muscle spasm, which signal can activate the upper body wearable device or can activate the electronic airbag to open. The airbag in an open state can provide certain buoyancy for the swimmer and protect the swimmer for his or her safety. Therefore, the swimming wearable device according to the embodiments of the present disclosure can reduce drowning accidents and improve safety of swimming exercise.

In one embodiment of the present disclosure, the swimming wearable device comprises at least two lower limb wearable devices. The upper body wearable device comprises at least one upper limb wearable device. Each upper limb wearable devices comprises an electronic airbag and the muscle condition monitoring device of each of the at least two lower limb wearable devices is connected by signal with each of the at least one upper limb wearable device or each electronic airbag. And when a muscle condition monitoring device of one of the at least two lower limb wearable devices detects muscle spasm, the muscle condition monitoring device sends a signal to the at least one upper limb wearable devices or to an electronic airbag of the at least one upper limb wearable device, thereby making the at least one upper limb wearable device activates its electronic airbag or activating the electronic airbag to open.

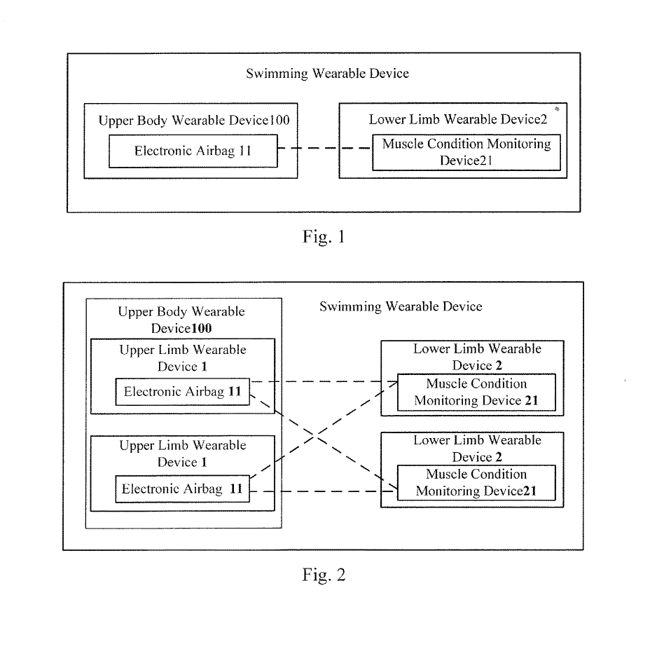

The numbers of the upper limb wearable device and the lower limb wearable device are not restricted, but can be one or plural according to the body weight and the body condition of the swimmer. As illustrated in FIG. 2, the swimming wearable device comprises two upper limb wearable devices 1 and two lower limb wearable devices 2, wherein:

each upper limb wearable device 1 comprises an electronic airbag 11; each lower limb wearable device 2 comprises a muscle condition monitoring device 21; each muscle condition monitoring device 21 is connected by signal with the two upper limb wearable devices 1 respectively or is connected by signal with the electronic airbags 11 of the two upper limb wearable devices 1 respectively; and when detecting muscle spasm, each muscle condition monitoring device 21 can send a signal to the two upper limb wearable devices 1 or the electronic airbags 11 of the two upper limb wearable devices, so as to make the two upper limb wearable devices I activate their electronic airbags 11 to open respectively or to activate the electronic airbags 11 of the two upper limb wearable devices 1.

When a swimmer wearing the swimming wearable device provided by the embodiments of the present disclosure swims, if a spasm in his/her leg or foot occurs, the muscle condition monitoring device 21 can send a signal to the two upper limb wearable devices 1 or the electronic airbags 11 of the two upper limb wearable devices 1, so that the two upper limb wearable devices I activate their electronic airbags 11 to open respectively or the electronic airbags 11 are activated to open. The electronic airbags 11 in an open state provide certain buoyancy for the swimmer and protect the swimmer for his or her safety.

The wearing portions of the upper limb wearable device 1 and the lower limb wearable device 2 are not restricted. For example, the upper limb wearable device 1 can be worn at a swimmer's wrist or forearm, and the lower limb wearable device 2 can be worn at a swimmer's ankle or calf. To improve sporting comfort and reduce binding sense, in one embodiment of the present disclosure, the upper limb wearable device 1 is worn at a swimmer's wrist and the lower limb wearable device 2 is worn at a swimmer's ankle.

In one embodiment of the present disclosure, the muscle condition monitoring device of each lower limb wearable device is connected by wireless signal with the electronic airbag of the at least one upper limb wearable device. As illustrated in FIG. 2, each muscle condition monitoring device 21 is connected by wireless signal with the electronic airbags 11 of the two upper limb wearable devices 1, for example, by Bluetooth or infrared connection. Connection by wireless signal between the muscle condition monitoring device 21 and the electronic airbag 11 can reduce binding sense of the swimmer and improve his/her comfort.

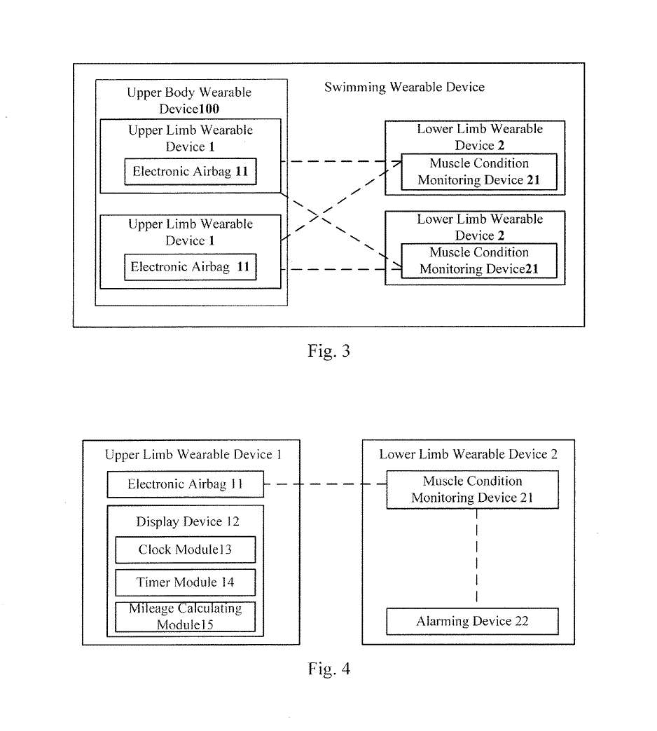

In another embodiment of the present disclosure, the muscle condition monitoring device of each lower limb wearable device is connected by wireless signal with the at least one upper limb wearable device. As illustrated in FIG. 3, each muscle condition monitoring device 21 is connected by wireless signal with two upper limb wearable devices 1, for example by Bluetooth or infrared connection. Connection between the muscle condition monitoring device 21 and the upper limb wearable device 1 by wireless signal can reduce binding sense of the swimmer and improve his/her comfort.

As illustrated in FIG. 4, to further improve the safety of swimming exercise, the lower limb wearable device 2 further comprises an alarming device 22 connected by signal with the muscle condition monitoring device 21. And when detecting muscle spasm, the muscle condition monitoring device 22 can activate the alarming device 22 to give an alarm. The alarming device 22 provides an alarm signal notifying the abnormality of the swimmer to others or a lifeguard, thereby reducing drowning accidents and further improving safety of swimming exercise, The type of the alarming device 22 is not restricted, but can be a sound alarm or an audible and visual alarm and the like, for example.

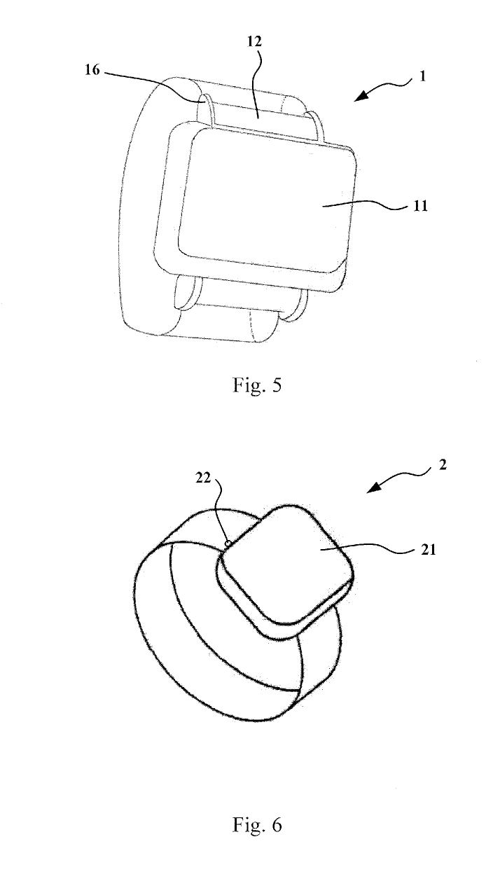

The structural forms of the upper limb wearable device 1 and the lower limb wearable device 2 are not restricted. For example, the upper limb wearable device 1 and the lower limb wearable device 2 can be of sticking type in which they are stuck and affixed to the upper and lower limbs of the swimmer respectively. As illustrated in FIG. 5 and FIG. 6, in the embodiment, to have the wearable device firmly affixed, the upper limb wearable device 1 is of arm wearing type, the lower limb wearable device 2 is of ankle wearing type, and the upper limb wearable device 1 and the lower limb wearable device 2 are ring-like as a whole and can enclose the swimmer's arm and ankle respectively and be affixed thereto.

In the embodiment as illustrated in FIG. 4, the upper limb wearable device 1 further comprises a display device 12. One of a clock module 13, a timer module 14 and a mileage calculating module 15 can be integrated in the display device 12 so that the upper limb wearable device 1 can have a function of time displaying, time calculating or swimming mileage calculating and etc. A swimmer can be aware of sport information conveniently and timely by observing display information of the display device 12. For example, the mileage calculating module 15 can be a GPS mileage calculating module or a vibration counting mileage calculating module.

As illustrated in FIG. 5, in the upper limb wearable device 1, the display device 12 is disposed on one side of the electronic airbag 11. The display device 12 and the electronic airbag 11 are disposed on a structural connection member 16 which serves a function of connecting, supporting and fixing. When being worn, the display device 12 and the electronic airbag 11 are disposed towards an outer side of an arm. A swimmer can learn his/her own sport information conveniently by observing the display device 12. Once a spasm in leg or foot occurs, the electronic airbag 11 can be timely popped up at the outer side of the arm so as to protect the safety of the swimmer.

Based on the same inventive concept, at least one embodiment of the present disclosure further provides an upper limb wearable device which comprises an electronic airbag. The muscle condition monitoring device of the lower limb wearable device is connected by signal with the upper limb wearable device or the electronic airbag of the upper limb wearable device. And when the muscle condition monitoring device detects muscle spasm, the muscle condition monitoring device sends a signal to the upper limb wearable device or the electronic airbag of the upper limb wearable device so as to make the upper limb wearable device activate the electronic airbag or activate the electronic airbag to open.

In one embodiment of the present disclosure, the upper limb wearable device comprises a display device in which at least one of a clock module, a timer module and a mileage calculating module is integrated.

Drowning accidents can be reduced and safety of swimming exercise can be improved by wearing the lower limb wearable device comprising the muscle condition monitoring device and the upper limb wearable device provided by the embodiments of the present disclosure.

It can be appreciated that in the various embodiments of the present disclosure, all the electronic components in the upper body wearable device and the lower limb wearable device should be designed in a waterproof manner. Alternatively, the upper body wearable device and the lower limb wearable device should adopt a waterproof design as a whole respectively.

The foregoing are merely exemplary embodiments of the disclosure, but are not used to limit the protection scope of the disclosure. The protection scope of the disclosure shall be defined by the attached claims.

The present disclosure claims priority of Chinese Patent Application No. 201510341563.1 filed on Jun. 18, 2015, the disclosure of which is hereby entirely incorporated by reference as a part of the present disclosure.

1. A swimming wearable device, comprising an upper body wearable device and a lower limb wearable device, wherein
the upper body wearable device comprises an electronic airbag; the lower limb wearable device comprises a muscle condition monitoring device; the muscle condition monitoring device is connected by signal with the upper body wearable device or with the electronic airbag of the upper body wearable device, and when detecting a muscle spasm in lower limb, the muscle condition monitoring device sends a signal to the upper body wearable device or the electronic airbag of the upper body wearable device, so as to make the upper body wearable device activate the electronic airbag to open or to activate the electronic airbag to open.

2. The swimming wearable device according to claim 1, wherein
the upper body wearable device comprises a vest-like upper body wearable device, a bandage-like upper body wearable device, a sticking upper body wearable device or an arm wearing upper body wearable device.

3. The swimming wearable device according to claim 1, wherein
the lower limb wearable device comprises an ankle wearing lower limb wearable device, a bandage-like lower limb wearable device or a sticking lower limb wearable device.

4. The swimming wearable device according to claim 1, comprising at least two lower limb wearable devices, the upper body wearable device comprising at least one upper limb wearable device, wherein
each upper limb wearable device comprises an electronic airbag and the muscle condition monitoring device of each of the at least two lower limb wearable device devices is connected by signal with the at least one upper limb wearable device or the electronic airbag of the at least one upper limb wearable device, and when detecting a muscle spasm, the muscle condition monitoring device sends a signal to the at least one upper limb wearable device or to the electronic airbag of the at least one upper limb wearable device, so as to make the at least one upper limb wearable device activate the electronic airbag to open or to activate the electronic airbag to open.

5. The swimming wearable device according to claim 4, wherein the lower limb wearable device comprises an alarming device which is connected by signal with the muscle condition monitoring device, and when detecting a muscle spasm, the muscle condition monitoring device activates the alarming device to give an alarm.

6. The swimming wearable device according to claim 4, wherein the muscle condition monitoring device of each lower limb wearable device is connected by wireless signal with the at least one upper limb wearable device or with the electronic airbag of the at least one upper limb wearable device.

7. The swimming wearable device according to claim 4, wherein the upper limb wearable device further comprises a display device.

8. The swimming wearable device according to claim 7, wherein at least one of a clock module, a timer module and a mileage calculating module is integrated in the display device.

9. The swimming wearable device according to claim 8, wherein the mileage calculating module comprises a GPS mileage calculating module or a vibration counting mileage calculating module.

10. The swimming wearable device according to claim 1, wherein the electronic airbag comprises a gas generator in which substance that can be rapidly decomposed to generate gas is stored.

11. An upper limb wearable device, comprising an electronic airbag, wherein the upper limb wearable device or the electronic airbag is connected by signal with a muscle condition monitoring device, and when detecting a muscle spasm, the muscle condition monitoring device sends a signal to the upper limb wearable device so as to make the upper limb wearable device activate the electronic airbag to open or to activate the electronic airbag to open.

12. The upper limb wearable device according to claim 11, wherein the upper limb wearable device further comprises a display device in which at least one of a clock module, a timer module and a mileage calculating module is integrated.

13. The upper limb wearable device according to claim 11, wherein the electronic airbag comprises a gas generator in which substance that can be rapidly decomposed to generate gas is stored.

14. The swimming wearable device according to claim 2, wherein
the lower limb wearable device comprises an ankle wearing lower limb wearable device, a bandage-like lower limb wearable device or a sticking lower limb wearable device.

15. The swimming wearable device according to claim 2, comprising at least two lower limb wearable devices, the upper body wearable device comprising at least one upper limb wearable device, wherein
each upper limb wearable device comprises an electronic airbag and the muscle condition monitoring device of each of the at least two lower limb wearable devices is connected by signal with the at least one upper limb wearable device or the electronic airbag of the at least one upper limb wearable device, and when detecting a muscle spasm, the muscle condition monitoring device sends a signal to the at least one upper limb wearable device or to the electronic airbag of the at least one upper limb wearable device, so as to make the at least one upper limb wearable device activates the electronic airbag to open or to activate the electronic airbag to open.

16. The swimming wearable device according to claim 3, comprising at least two lower limb wearable devices, the upper body wearable device comprising at least one upper limb wearable device, wherein
each upper limb wearable device comprises an electronic airbag and the muscle condition monitoring device of each of the at least two lower limb wearable devices is connected by signal with the at least one upper limb wearable device or the electronic airbag of the at least one upper limb wearable device, and when detecting a muscle spasm, the muscle condition monitoring device sends a signal to the at least one upper limb wearable device or to the electronic airbag of the at least one upper limb wearable device, so as to make the at least one upper limb wearable device activates the electronic airbag to open or to activate the electronic airbag to open.
